(19) United States
(12) Patent Application Publication
(10) Pub. No.: US 2009/0068544 A1
(43) Pub. Date: Mar. 12, 2009

(54) FUEL CELL USING POLYHYDRIC MIXTURES DIRECTLY AS A FUEL

(75) Inventors: Steven Ragsdale, Mill Creek, WA (US); Chris Ashfield, Seattle, WA (US)

Correspondence Address: JEFFREY B. OSTER, 8339 SE 57TH ST, MERCER ISLAND, WA, 98040, US

(73) Assignee: CyVolt Energy Systems, Inc., Seattle, WA (US)

(21) Appl. No.: 12/205,873

(22) Filed: Sep. 6, 2008

Related U.S. Application Data
(60) Provisional application No. 60/970,944, filed on Sep. 8, 2007.

(51) Int. Cl. H01M 8/00; C10L 1/18

(52) U.S. Cl. 429/43; 429/42; 44/308

(57) ABSTRACT

There is disclosed a fuel cell having an anode and cathode and using either glycerol or biodiesel process waste (containing about 90% glycerol) as a fuel source to generate power and oxidize glycerol to oxidized fragments and carbon dioxide. More particularly, there is disclosed a liquid fuel cell incorporating a membrane-electrode assembly (MEA) wherein the electrocatalysts are embedded in or adjacent a polymeric conducting membrane with which they form the fuel cell body and glycerol or biodiesel process waste is oxidized to form the power source.

### CROSS REFERENCE TO RELATED APPLICATION

This patent application claims priority from U.S. Provisional Patent application 60/970,944 filed 8 Sep. 2007.

### TECHNICAL FIELD

The present disclosure provides a fuel cell having an anode, a cathode, an electrolyte and a fuel mixture. More particularly, the invention disclosure provides for liquid fuel compositions for fuel cells derived from crude glycerin. The fuel cells comprise a polymeric-ion conducting membrane and electrocatalyst oxidize the fuel directly and with an air-oxidant form a low-temperature power source in the presence of an external resistive load.

### BACKGROUND

Fuel cells are electrochemical devices that convert the chemical energy of a reaction into electrical power. In such cells, a fuel and an oxidant (generally oxygen from air) are supplied at the electrodes. Theoretically, a fuel cell can produce electrical energy for as long as the fuel and oxidant are supplied to the electrodes. In reality, degradation or malfunction of the components limits the practical operating life of fuels cells.

A variety of fuel cells are known. In U.S. Pat. Nos. 3,013,908 and 3,113,049, a direct methanol fuel cell (DMFC) is described. Some fuel cells have a membrane electrode assembly (MEA) with a proton exchange membrane (PEM). Examples include fuel cells using H₂, direct fuel cells oxidize fuels directly without reforming a hydrogen-containing liquid, solid or gaseous fuel, including alcohols and polyhydric alcohols (methanol, ethanol, ethylene glycol), and other direct oxidation fuel cells (sugars, carbohydrates, aldehydes, saturated hydrocarbons, carboxylic acids, alkali metal borohydrides, hydrazine).

Common components of a fuel cell are an electrolyte, an ion-conductive polymeric membrane, and electrodes (anode and cathode). The electrodes contain metals or metal particles, often dispersed on conductive, porous support materials. The electrodes incorporate a catalyst to enhance the rates of the electrode reactions. The membrane has the role of separating the electrodes and allows the transport or conduction of ions. An ion-exchange polymer electrolyte membrane is either a cation conducting polymer or an anion conducting polymer.

MEA or membrane electrode assembly is an ion-exchange polymer electrolyte membrane on both sides of which are the electrodes (on one side the cathode, or positive electrode, and the anode, or negative electrode onto the other side). The electrodes are generally formed by conductive and gas-permeable materials (for example graphitic materials) on which are deposited metal complexes, metals or metal particles. Catalysts employed for oxidizing the fuel (for example H₂, methanol or other short-chain alcohol) are often platinum, platinum in conjunction with other metals (e.g., ruthenium, ruthenium-molybdenum, tin), gold (activated), silver, or nickel in conjunction with iron and/or cobalt. The electrodes and the ion-exchange membrane should be contiguous and optimizing the mutual conjunction of these components optimizes the performance of the fuel cell. In the case of proton-exchange membrane, the cathode side of the membrane typically cannot be directly metallized by the metal element that catalyzes the oxygen reduction because the water that forms during the electrochemical reaction hinders the adsorption and diffusion of oxygen to the catalyst surface. Moreover, the membrane can become fouled or clogged due to various salt deposits, leading to the fuel cell ceasing to function properly, thereby wasting expensive noble metal catalysts. Anion exchange membrane fuel cells have MEAs containing an anion-exchange membrane allows hydroxide ion conduction from the cathode to the anode and can be used in direct alcohol fuel cells (for example, the reversible potentials of ethanol and methanol are −0.743 and −0.770 V in alkaline medium and +0.084 and +0.046 V in acidic medium, respectively) (PCT/EP 2003/006592).

PEM membranes have demonstrated excellent chemical, mechanical, thermal, electrochemical stability and high ionic conductivity. The kinetics of fuel oxidation and oxygen reduction at the electrode—membrane—electrode interfaces has been found to be more facile in an alkaline environment, such as in a fuel cell containing an AEM (anion exchange membrane). Whereas PEM fuel cells can be operated at temperatures as high as 120° C. for Nafion-type fluoro polymers, AEM fuel cells tends to degrade at temperatures higher than 80° C.

Biodiesel processing from various plant triglyceride oils (such as soy oil and palm oil) creates the methyl esters that are used for diesel fuel and approximately 10-15% (by volume) of a waste product that is crude glycerol in an alkaline solution. The waste product can be purified to pure glycerol, but a glut of glycerol has severely depressed prices and demand (mostly for cosmetics and lotions) has not increased despite the increase in supply. Therefore, there is a need to either find new uses for pure glycerol or to find uses for the crude biodiesel waste product. The present disclosure addresses this need. Given the rising supply of biodiesel waste and the lack of an ability to dispose of it, there is a need to be able to make productive use of this waste product that does not generate an even greater waste problem.

### SUMMARY

This disclosure provides a process and fuel cell design that can utilize biodiesel waste as a fuel source to generate power and oxidize the glycerin waste into various oxidation products. A polyhydric alcohol mixture is used as fuel in a direct oxidation fuel cell. Such a fuel cell shows higher performance than a direct methanol fuel cell (DMFC) and other currently reported direct oxidation fuel cells.

The present disclosure provides a method for using a liquid fuel composition obtained from biodiesel waste as the fuel in a fuel cell having an anion exchange membrane, wherein the liquid fuel composition comprises 5-80% glycerin, 1-20% hydroxyl ion, 0.5-10% methanol, and from about 1-40% of impurities selected from the group consisting of trace methyl or ethyl esters, ethanol, ethylene glycol, propanol, soaps, incomplete transesterification of triglycerides, and mixtures thereof. Preferably, the hydroxyl ion is from a salt selected from the group consisting of LiOH, NaOH, KOH and mixtures thereof.

The present disclosure provides a fuel cell device for oxidizing a biodiesel processing waste comprising:

(a) a chamber having a first and a second sealed outer walls defining an inner chamber having three compartments;

(b) an oxygen compartment defined be the first outer wall of the chamber and a cathode polymeric strand electro-catalyst assembly;

(c) a biodiesel waste compartment defined by the second outer wall of the chamber and an a anode polymeric strand electro-catalyst assembly; and

(d) an electrolyte compartment defined by the cathode polymeric strand electro-catalyst assembly and the anode polymeric strand electro-catalyst assembly, wherein the electrolyte compartment comprises a base solution.

Preferably, the anode and cathode polymeric strand electro-catalyst assembly comprise (i) a porous conducting polymer material, (ii) coated with an electrically conductive metal layer that, itself, acts as a support material for (iii) catalytically active metals or metal compounds. Preferably, the metallic coating layer is composed of a metal compound selected from the group consisting of Ag, Au, Ni, Co, Cu, Pd, Sn, Ru, and alloys thereof. Preferably the metallic coating layer is selected from the group consisting of nickel and cobalt citrate, potassium tetrachloroplatinate, silver nitrate, cobalt nitrate, potassium tetrachloroaurate, and mixtures thereof. Preferably, the anode polymeric strand electro-catalyst assembly is made from a metal selected from the group consisting of Pt, Au, Ag, Ni, Co, Fe, Ru, Sn, Pd, and combinations thereof. Most preferably, the porous conducting polymer material is composed of a polymeric material selected from the group consisting of polyporryphrin, polyolefins, fluorinated ethylene/polypropylene copolymers, polysulfones, ethylene oxide-polyepichlorohydrin copolymers, chloromethylation or sulfochloromethylation. Preferably, the ethylene oxide-polyepichlorohydrin copolymers are prepared by grafting with radiation. Most preferably, the anode catalysts are selected from the group consisting of Pt, Au, Ag, Ni, Co, Fe, Ru, Sn, Pd and combinations thereof. Most preferably, the cathode catalysts are selected from the group consisting of cobalt, nickel and rhodium phthalocyanine or tetraphenylporphyrin, Co N,N′-bis(salicylidene)ethylendiamine, Ni N,N′-bis(salicylidene)ethylendiamine silver oxide, and combinations thereof. Preferably, the oxygen compartment further comprises an oxygen source that is a gas or a liquid, wherein the gas is air or pure oxygen. Preferably, the base solution is selected from the group consisting of potassium hydroxide, sodium hydroxide, hydrazine, hydrazine hydrate, alkali metal borohydrides, alkaline metal hydrosulfite, alkaline metal sulphites, and combinations thereof.

The present disclosure further provides a liquid fuel cell that utilizes glycerol or biodiesel waste as a fuel, comprising:

(a) an anode chamber comprising a sealed endplate, an anion exchange membrane having a first side and a second side, and the glycerol or biodiesel processing waste fuel, wherein the endplate and the first side of the anion exchange membrane form the anode chamber; and

(b) a oxygen chamber comprising a second sealed endplate, the second side of the anion exchange membrane, a cathode polymeric strand electro-catalyst assembly, and an oxygen source.

Preferably, the oxygen source is a gas or a liquid, wherein the gas is air or pure oxygen, and wherein the liquid is a peroxide solution. Preferably, the anion exchange membrane is made from a quaternized polymers selected from the group consisting of polysiloxane containing a quaternary ammonium group, poly(oxyethylene)methacrylates containing ammonium groups, quaternized polyethersulfone cardo anion exchange membranes, radiation-grafted polyvinylidene fluoride (PVDF) and polytetrafluoroethylene-co-hexafluoropropylene (FEP), and combinations thereof. Preferably, the anode and cathode membrane electrode assembly (MEA) comprise (i) a porous conducting polymer material, (ii) coated with an electrically conductive metal layer that, itself, acts as a support material for (iii) catalytic metals or metal compounds. More preferably, the metallic coating layer is composed of a metal compound selected from the group consisting of Ag, Au, Ni, Co, Cu, Pd, potassium tetrachloroplatinate, silver nitrate, cobalt nitrate, potassium tetrachloroaurate, and combinations thereof. More preferably, the anode MEA is made from a metal selected from the group consisting of Pt, Au, Ag, Ni, Co, Fe, Ru, Sn, Pd, and combinations thereof. Most preferably, the porous conducting polymer material is composed of a polymeric material selected from the group consisting of polyporryphrin, polyolefins, fluorinated ethylene/polypropylene copolymers, polysulfones, ethylene oxide-polyepichlorohydrin copolymers, chloromethylation or sulfochloromethylation.

The present disclosure further provides a liquid fuel cell that utilizes glycerol or biodiesel waste as the fuel, comprising:

(a) an anode chamber comprising a sealed endplate, the glycerol or biodiesel waste fuel, and anode membrane electrode assembly, and a proton exchange membrane having a first side and a second side, wherein the endplate and the first side of the proton exchange membrane form the anode chamber, and

(b) a oxygen chamber defined by a second sealed endplate and the second side of the proton exchange membrane and comprising a cathode polymeric strand electro-catalyst assembly (cathode MEA) and an oxygen source.

Preferably, the oxygen source is a gas or a liquid, wherein the gas is air or pure oxygen, and wherein the liquid is a peroxide solution. Preferably, the proton exchange membrane (PEM) is made from a fluoropolymer having sulfonated functional groups, wherein the fluoropolymer having sulfonated functional groups is a poly-perfluorovinyl ether terminated with sulfonate groups onto a tetrafluoroethylene (Teflon) backbone. Preferably, the anode and cathode membrane electrode assembly (MEA) comprise (i) a porous conducting polymer material, (ii) coated with an electrically conductive metal layer that, itself, acts as a support material for (iii) catalytically active metals or metal compounds. More preferably, the metallic coating layer is composed of a metal compound selected from the group consisting of Ag, Au, Ni, Co, Cu, Pd, Sn, Ru, potassium tetrachloroplatinate, silver nitrate, cobalt nitrate, potassium tetrachloroaurate, and combinations thereof. More preferably, the anode MEA is made from a metal selected from the group consisting of Pt, Au, Ag, Ni, Co, Fe, Ru, Sn, Pd compounds, and combinations thereof. Most preferably, the porous conducting polymer material is composed of a polymeric material selected from the group consisting of polyporryphrin, polyolefins, fluorinated ethylene/polypropylene copolymers, polysulfones, ethylene oxide-polyepichlorohydrin copolymers, chloromethylation or sulfochloromethylation. Most preferably, the anode catalysts are selected from the group consisting of Pt, Au, Ag, Ni, Co, Fe, Ru, Sn, Pd, and combinations thereof. Most preferably, the cathode catalysts are selected from the group consisting of cobalt, nickel and rhodium phthalocyanine or tetraphenylporphyrin, Co N,N′-bis(salicylidene)ethylendiamine, Ni N,N′-bis(salicylidene)ethylendiamine, silver nitrate, and combinations thereof.

### BRIEF DESCRIPTION OF THE DRAWINGS

FIG. 1 shows a schematic of the fuel cell used in the examples provided herein.

FIG. 2 is a graph of cell voltage (V), current (mA), and corresponding power (mW) at a given resistance for a fuel cell containing a proton-exchange membrane, a Pt—Ru/C anode, a Pt/C cathode, 1.5 M glycerol fuel, and ambient-air oxidant.

FIG. 3 is a graph of voltage response (V) and corresponding energy (mWh) at a constant resistive load for a fuel cell containing a proton-exchange membrane, a Pt—Ru/C anode, a Pt/C cathode, 1.5 M glycerol fuel, and ambient-air oxidant.

FIG. 4 is a graph of voltage response (V) and corresponding energy (mWh) at a constant resistive load for a fuel cell containing a proton-exchange membrane, a Pt—Ru/C anode, a Pt/C cathode, 10% ethanol fuel, and ambient-air oxidant.

FIG. 5 is a graph of cell voltage (V), current (mA), and corresponding power (mW) at a given resistance for a fuel cell containing a proton-exchange membrane, a Pt—Ru/C anode, a Pt/C cathode, 1 M ethylene glycol fuel, and ambient-air oxidant.

FIG. 6 is a graph of voltage response (V) and corresponding energy (mWh) at a constant resistive load for a fuel cell containing a proton-exchange membrane, a Pt—Ru/C anode, a Pt/C cathode, 1 M ethylene glycol fuel, and ambient-air oxidant.

FIG. 7 is a graph of cell voltage (V), current (mA), and corresponding power (mW) at a given resistance for a fuel cell containing a proton-exchange membrane, a Pt—Ru/C anode, a Pt/C cathode, 3 M propanediol fuel, and ambient-air oxidant.

FIG. 8 is a graph of cell voltage (V), current (mA), and corresponding power (mW) at a given resistance for a fuel cell containing an anion-exchange membrane, a Pt—Ru/C anode, a Pt/C cathode, 3% methanol fuel, 1 M KOH, and ambient-air oxidant.

FIG. 9 is a graph of cell voltage (V), current (mA), and corresponding power (mW) at a given resistance for a fuel cell containing an anion-exchange membrane, a Pt—Ru/C anode, a Pt/C cathode, 3% methanol fuel, 1 M KOH, and ambient-air oxidant.

FIG. 10 is a graph of cell voltage (V), current (mA), and corresponding power (mW) at a given resistance for a fuel cell containing an anion-exchange membrane, a Pt—Ru/C anode, a Pt/C cathode, 5% glycerol fuel, 3 M KOH, and ambient-air oxidant.

FIG. 11 is a graph of voltage response (V) and corresponding energy (mWh) at a constant resistive load for a fuel cell containing an anion-exchange membrane, a Pt—Ru/C anode, a Pt/C cathode, 5% glycerol fuel in 3 M KOH, and ambient-air oxidant.

FIG. 12 is a graph of cell voltage (V), current (mA), and corresponding power (mW) at a given resistance for a fuel cell containing an anion-exchange membrane, a Pt—Ru/C anode, a Pt/C cathode, 25% glycerol fuel, 3 M KOH, and ambient-air oxidant.

FIG. 13 is a graph of voltage response (V) and corresponding energy (mWh) at a constant resistive load for a fuel cell containing an anion-exchange membrane, a Pt—Ru/C anode, a Pt/C cathode, 50% glycerol fuel, saturated KOH, and ambient-air oxidant.

FIG. 14 is a graph of voltage response (V) and corresponding energy (mWh) at a constant resistive load for a fuel cell containing an anion-exchange membrane, a Pt—Ru/C anode, a Pt/C cathode, 10% crude glycerol fuel, saturated KOH and ambient-air oxidant.

FIG. 15 is a graph of cell voltage (V), current (mA), and corresponding power (mW) at a given resistance for a fuel cell containing an anion-exchange membrane, a Pt—Ru/C anode, a Pt/C cathode, 25% crude glycerol fuel, saturated KOH, and ambient-air oxidant.

FIG. 16 is a graph of cell voltage (V), current (mA), and corresponding power (mW) at a given resistance for a fuel cell containing an anion-exchange membrane, a Pd—Ni—Fe anode, a Pd—Co cathode, 25% crude glycerol fuel, saturated KOH, and ambient-air oxidant.

FIG. 17 is a graph of voltage response (V) and corresponding energy (mWh) at a constant resistive load for a fuel cell containing an anion-exchange membrane, a Pd—Ni—Fe anode, a Pd—Co cathode, 25% crude glycerol fuel, saturated KOH, and ambient-air oxidant.

FIG. 18 is a graph of voltage response (V) and corresponding energy (mWh) at a constant resistive load for a fuel cell containing a proton-exchange membrane, a Pt—Ru/C anode, a Pt/C cathode, 30% methanol fuel, and ambient-air oxidant.

FIG. 19 is a graph of voltage response (V) and corresponding energy (mWh) at a constant resistive load for a fuel cell containing a proton-exchange membrane, a Pt—Ru/C anode, a Pt/C cathode, 30% isopropyl alcohol fuel, and ambient-air oxidant.

FIG. 20 is a graph of cell voltage (V), current (mA), and corresponding power (mW) at a given resistance for a fuel cell containing an anion-exchange membrane, a Pt—Ru/C anode, a Pt/C cathode, 3 M propanediol fuel, 3 M KOH, and ambient-air oxidant.

### DETAILED DESCRIPTION

The present disclosure provides a direct oxidation fuel cell for bio-renewable byproducts, such as polyhydric compounds consisting of the group containing glycerin and other secondary poly-alcohols as the fuel. It is an object of this disclosure to provide a fuel cell using secondary alcohols and polyalcohols as the fuel. It is another object of the disclosure to provide a fuel cell using crude glycerin and polyhydric alcohol mixtures as the fuel. It is yet another object of this disclosure to provide a fuel cell whose fuel crossover is much less than a typical direct methanol fuel cell (DMFC) using a proton exchange membrane (PEM). It is yet another object of this disclosure to provide a fuel cell whose anode catalyst is electrochemically active for the direct oxidation of fuels obtained from biodiesel processing waste. It is yet another object of this disclosure to provide a fuel cell whose cathode catalyst is electrochemically active for ambient-air oxidant.

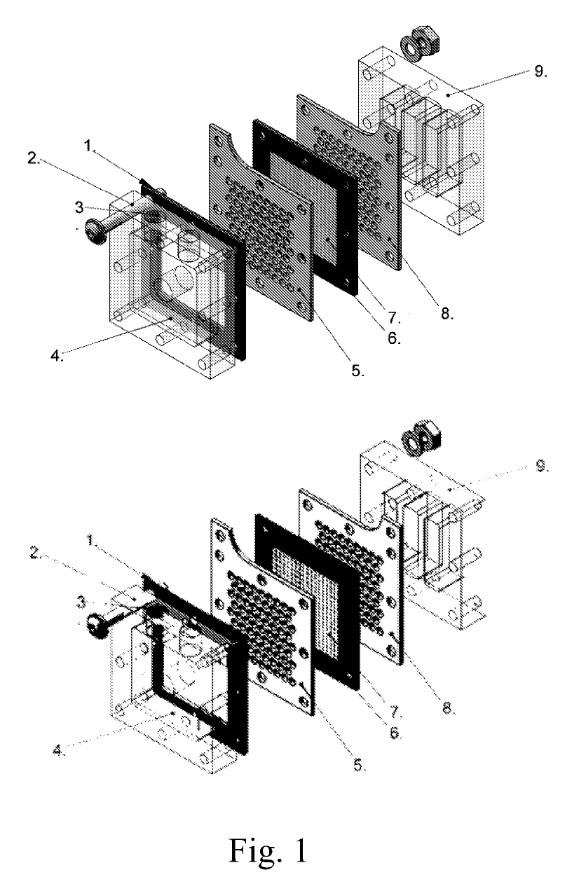

A schematic of the fuel cell used is shown in FIG. 1. Specifically, FIG. 1 depicts a typical single-cell direct fuel cell where 7 is a MEA consisting of a membrane, an anode electrode and a cathode electrode. In the assembled cell the electrodes are in contact with current collectors 5, 8 to provide electrical conduction from the electrodes to an external load. To prevent electrical short circuiting and to seal the cell gaskets 1, 6 are used. In addition, 1 has the function of sealing the fuel reservoir 4 that is embedded in the anode plate 2 such that fuel injected into the fuel cell through the inlet and outlet ports 3 will be contained within the cell. The single cell design has stripped out the balance of plant such that the disclosed embodiments are examples of a passive fuel cell, operating under ambient temperature and pressure with improved performance. The cathode operates using ambient-air as the oxidant. The cathode plate 9 has slots that allow air to reach the cathode.

In a preferred embodiment, fuel mixtures are obtained from crude biodiesel waste for use in a direct fuel cell. Without being bound by theory, the undergoing oxidation reaction in the fuel cell facilitated cleavage of carbon-oxygen or carbon-carbon bonds. Although the bond cleavage was facilitated at various anode catalysts, oxidation reactions that did not require breaking of the carbon-carbon were also observed. For example, converting glycerin into oxidized products, such as the following oxidation products of glycerol, were observed in the direct fuel cells and disclosed herein. Oxidized products of glycerol that were identified include, lactic acid, glycolic acid, polyether, 1,2,3-butanetriol, glyceric acid, and tartronic acid. In addition, selective oxidation of glycerol in a fuel cell include, but are not limited to dihydroxyacetone, glyceraldehydes, hydroxymethyl glyoxal, hydroxypyruvic acid, mesoxalic acid, oxalic acid, glyoxylic acid, and formic acid. These species were identified by using GC/MS.

### Crude Glycerin Composition

The concentration of glycerol may range from 5% to 80% by weight in water and is preferably from 30% to 50% by weight. A fuel composition of from about 10% to about 35% glycerin, and from about 0.2% to about 10% C1 to C4 alkyl alcohol is also preferred. The composition, including from about 1% to 15% residue by-product from the oxidation reaction of glycerol in a fuel cell, produces multiple oxidation products that are oxidized into multiple carboxylic acids, aldehydes and polyalcohols. The continued oxidation of these residual products leads to extended power and prolonged use of the disclosed fuel cells. Such output is surprising and is not typical for fuel cells practiced in the prior art.

One preferred source of the polyhydric fuel is crude glycerin obtained as a byproduct of the transesterification of glycerides from bio-renewable resources (i.e., biodiesel processing). The tendency of crude glycerin is for it to darken. This is due to the presence of water and non-glycerin organic matter. Crude glycerin obtained as a byproduct of the biodiesel industry was used instead of refined or USP glycerol. Biodiesel is produced using fats and oils. The processes and procedures described in this disclosure are generally applicable to refined glycerol as well as crude glycerol.

Crude Glycerin obtained from a biodiesel manufacturer (T-1100 composite from Imperium Renewables, Seattle and Grays Harbor, Wash.) was prepared for use in a direct fuel cell. The crude glycerin was analyzed internally in a laboratory at the biodiesel manufacturer. The composition of the crude glycerin used to prepare the polyhydric fuel mixture used herein had an approximate composition as listed in Table 1.

Soap lye crude glycerol (Soap lye crude glycerol was prepared by evaporation of the purified lyes obtained from the manufacture of soap.) Hydrolyser crude glycerol was prepared by evaporation of the sweet waters obtained from the hydrolysis of fats under pressure or in the presence of catalysts. Crude Glycerine sourced from Europe with the purity of 90-93% minimum is also available (see composition in Table 1.).

TABLE 1

| Component | Units | Test Method | T-1100 | Soap Lye** | Hydrolyser | Crude (EU)*** |
|---|---|---|---|---|---|---|
| Glycerin | % wt | AOCS Ea 6-94 | 73.2 | 80 | 88 | 90-93 |
| Methanol | % wt | GC/FID | <2 | | | — |
| Water | % wt | AOCS Ea 8-58 | <1* | 10 | — | 1-3 |
| Alkalinity | pH | Direct Insertion | 7.5 | | | neutral |
| Ash | % wt | AOCS Ea 2-38 | <8%* | 10 | 1 | 4-6 |
| M.O.N.G.* | % wt | Calculation | 17.8 | 2.5 | 1.5 | 0.5-1.0 |
| 1,3 Propanediol | % wt | GC/FID | — | 0.5 | 0.5 | — |
| Salt (Chloride) | % wt | 70% KCl | — | — | — | 4% |

*M.O.N.G. = matter organic non-glycerol
**Woollatt, E., The Manufacture of Soaps, Other Detergents and Glyerine, Ellis Horwood, Ltd., Chichester, UK, 1985. (Originally British Standard Specifications.)
***http://www.oilbaseindia.com/castor.html#crude

### Preparation of Polyhydric Fuel Mixtures

Preparation of the polyhydric fuel mixture included neutralizing and diluting the crude glycerin and forming a substantially insoluble solid salt, soap and oil layer, then separating the resulting clarified polyhydric mixture. A process for producing a preferred fuel mixture from crude glycerin comprises the following steps including adjusting the pH of the crude glycerin to achieve an alkaline pH greater than pH 7 using an alkali hydroxide, separating polyhydric alcohol fuel and water from the crude glycerin. The amount of organic matter in the polyhydric feedstock was substantially dependent upon the fat or oil from which the glycerol was obtained. The organic matter (other than glycerol) is typically fatty-acid derivatives. One method for mitigating residual organic matter is by filtration. Alternatively, one can decant insoluble organics from the crude glycerin in a gravity separator at temperatures between 15 and 60° C.

In another preparation method, an anion-exchange resin was used in a column and the crude glycerin was run through the column. The clarified glycerol was then suitable for use in a fuel cell.

The polyhydric fuel source may contain high amounts of water. The ability to use polyhydric fuels that contain high amounts of water can advantageously reduces costs for this process over other uses for glycerin. The water content in the polyhydric fuel mixture was between 50 to 95%. In a preferred fuel mixture the combined concentrations of C1 to C6 alcohols was more than about 50%.

Various polyhydric compounds were identified to be present in prepared fuel mixtures obtained from crude glycerin samples and were used successfully as fuels in the fuel cells described in this disclosure. Polyhydric alcohols identified include ethylene glycol, glycolic acid, 3-Methoxy-1,3-propanediol, 1,2,3-butanetriol, 1,2,3,4,5-pentanol, and 1,4-benzenedicarboxylic acid.

### Catalysts

A catalyst is preferably a heterogeneous catalyst selected from the group consisting of platinum, ruthenium, palladium, iridium, rhodium, gold, nickel, iron, cobalt, titanium, copper, zinc, chromium, and combinations thereof. Suitable catalysts include, without limitation, metals such as platinum, ruthenium, palladium, iridium, rhodium, gold, nickel, iron, cobalt, titanium, copper, zinc, chromium, and combinations thereof. Catalysts may be deposited on any suitable substrate, such as alumina, and alumina oxides, silica, and carbon.

Commercial catalysts preferably include, for example, 80% Platinium—Ruthenium on Vulcan XC-72 (Fuel Cell Store, Item #: 592778); Copper chromite catalyst, BaO 9.7%; Raney-Nickel; Copper chromium catalyst; Nickel, 65 wt. % on silica/alumina (powder surface area 190 m²/g. Reduced and stabilized. Aldrich 208779), and others.

Barium and manganese increase the stability of the catalyst, that is, the effective catalyst life. The nominal compositions for barium expressed as barium oxide can vary 0-20 wt % and that for silica/alumina can vary from 0-35 wt %.

A preferred class of catalyst is the copper chromite catalyst, (CuO)ₓ(Cr₂O₃)_{y}. In this class of catalyst, the nominal compositions of copper expressed as CuO and chromium expressed as Cr₂O₃ may vary from about 30-80 wt % of CuO and 20-60 wt % of Cr₂O₃. Catalyst compositions containing about 40-60 wt % copper and 40-50 wt % of chromium are preferred. Another preferred catalyst is a powder catalyst at 30 m²/g surface area, 45% CuO, 47% Cr₂O₃, 3.5% MnO₂ and 2.7% BaO.

Catalytic hydrogenation of glycerol using a copper/zinc catalyst at temperatures greater than 200° C. is disclosed in U.S. Pat. No. 5,214,219 and U.S. Pat. No. 5,266,181.

### Membranes

The electrode kinetics of oxygen reduction are enhanced in an alkaline medium. A promising advantage of alkaline direct fuel cells is the use of nonprecious metals, such as silver catalysts and perovskite-type oxides. These catalysts are not only inexpensive, they are also tolerant to fuel crossover, and are active for the reduction of oxygen to OH⁻ in alkaline solution, but are almost inactive for alcohol oxidation.

Alkaline fuel cells have advantages over proton exchange membrane fuel cells for both cathode kinetics and ohmic polarization. The faster kinetics of the oxygen reduction reaction in an alkaline fuel cell allows the use of non-noble metal electrocatalysts that contribute directly to lower short-term costs also have environmental benefits. In addition, the anodic oxidation of glycerol in alkaline media is more viable than that in acidic media.

Anion exchange membranes are based on quaternized polymers applied for alkaline alcohol fuel cells, such as, polysiloxane containing a quaternary ammonium group, poly(oxyethylene)methacrylates containing ammonium groups, quaternized polyethersulfone cardo anion exchange membranes, radiation-grafted PVDF and FEP.

Preferred membranes are anion-exchange membranes based on quaternized polymers applied for alkaline alcohol fuel cells, such as, polysiloxane containing a quaternary ammonium group, poly(oxyethylene)methacrylates containing ammonium groups, quaternized polyethersulfone cardo anion-exchange membranes, and radiation-grafted PVDF and FEP.

Commercially Available Anion-Exchange Membranes include, for example, Tokuyama: AHA—006; AGC: AMT, ASV, AHT, AMV; eVionyx: and an AEM composition.

### Custom Membranes

This example illustrates the preparation of an OH⁻ form anion exchange membrane. Ammonium-type anion exchange membranes, e.g., Cl⁻ form membranes available from Tokuyama Co., Japan, are used as the membrane or electrolyte in a direct-fuel cell. In a preferred embodiment, the membrane or electrolyte is composed of fixed cation groups, such as tetraalkyl ammonium groups, bonded to a polyolefin backbone chain. The Cl⁻ form of the membrane or electrolyte is converted to the OH⁻ form. The Cl⁻ form membranes are rinsed several times with ultra-pure water, and then immersed in a 1 M KOH aqueous solution at 40° C. for 2 hours to exchange Cl⁻ with OH⁻. The membranes are washed with ultra-pure water and then immersed in ultra-pure water at 40° C. for 2 hours and at 25° C. for 24 hours. Conductivity of this type of membrane is 5-50 mS/cm and the membrane thickness ranges from 20 μm to 500 μm.

The preparation of quaternized polyethersulfone Cardo membrane is a three step process. First, 20 g polyethersulfone Cardo polymer (PES-C, average molecular weight 120,000) is dissolved in 100 ml of 1,2-dichloroethane at room temperature. The solution of PES-C is heated to 60° C. with reflux condensation under stirring. Then the complex solution of chloromethylether and zinc chloride is prepared, with 1.5 g ZnCl dissolved into 20 g chloromethylether. The total amount of the prepared complex solution is added into the PES-C solution, and the reaction is processed for 6 h at 60° C. and cooled to room temperature. Then, the polymer solution is gradually precipitated into hot water under mechanical agitation. Chloromethylated polymer is precipitated from solution, and filtered, washed several times with distilled water and dried under vacuum at 60° C. for 24 hours. Then, the chloromethylated PES-C is dissolved in dimethyldormamide to make a 10 wt % solution, which is then cast onto a flat glass. The cast membrane is dried at 60° C. for 6 hours. After cooling to room temperature, the resultant membrane is peeled from the glass in distilled water. This membrane is immersed into 30 wt % trimethylamine solution for 48 h to induct quaternary groups into the membrane. Then the membrane is put into 1 M NaOH solution for 24 hours. The quaternized PES-C (QPES-C) membrane is washed several times with distilled water and stored wet until use.

The chemical stability of QPES-C membrane is investigated by immersing the membrane into NaOH solution. Membrane is steady in NaOH solutions up to concentrations of 2 M at room temperature. Over this concentration, a white color is observed on the membrane, which means that the structure of membrane is degraded. At 70° C., this degradation is faster in 2 M NaOH solution. In addition, membrane is steady in 1 M NaOH solution over the temperature range 25-70° C.

Ion exchange capacity of QPES-C membranes is 1.25 meq/g. Ionic conductivity increases with increasing the NaOH solution concentration. It reaches a maximum value when the NaOH solution concentration is 4 M. Ionic conductivities are superior to 10⁻² S/cm for NaOH concentrations between 0.3 and 6.5 M (5.24×10⁻² S/cm was obtained in 4M OH⁻ at room temperature). The QPES-C membrane has adequate conductivity for fuel cell application.

The Teflon (ethylene trifluoroethylene) ETFE-based anion exchange membranes (AEMs) are produced using, for example, an irradiation procedure. ETFE (25-μm thick, Nowoflon ET-6235 film), available from Nowofol, Germany, is irradiated with an electron source. The irradiated ETFE is then submerged in nitrogen-purged vinylbenzyl chloride monomer (VBC, Dow Chemicals, 1:1 meta-/para-mix, used as received without removal of inhibitors) at 60° C. for 120 hours. The resulting ETFE grafted-poly(vinylbenzyl chloride) copolymer is immersed in aqueous trimethylamine (50% wt, Acros Organics) at room temperature for 4 hours. Immersion of the resulting anion-exchange membrane in 1 M OH⁻ for 1 hour yielded the target AEM. The AEM has a thickness of 50 μm and an ion-exchange capacity of 1.4 meq/g (as determined using a standard back titration method). The thermal stability of the membrane is up to 120° C.

For the preparation of membrane containing quaternary ammonium groups, five grams of (poly(phthalazinone ether sulfone ketone) PPESK is dissolved in 50 ml chloroform at room temperature. Excess paraformaldehyde and hydrochloric acid (HCl), as chloromethylation agents, and zinc chloride (ZnCl₂) as catalyst are used to perform the chloromethylation reaction. The mixture is then vigorously stirred for 5 hours at 0° C. The reaction product, chloromethylated poly(phthalazinon ether sulfone ketone) or CMPPESK, is precipitated with ice water. Finally, the CMPPESK is filtered and washed with distilled-deionized water until neutral in pH and then dried under vacuum at 60° C. for 24 hours.

The CMPPESK is dissolved in N-methylpyrolidone (NMP) to make a 5 wt % solution. This solution is cast on a glass plate and dried at 70° C. for 24 hours. The membrane is unstuck from the glass plate in the aid of 80 wt % ethanol/water solution. The cast membrane is soaked in 30 wt % trimethylamine solution at 90° C. for 10 hours to introduce quaternary ammonium groups into the membrane. The membrane thickness is controlled in the range of 20-200 μm. Before the use, the membranes are treated by immersing in 1 M KOH solution overnight to convert the membrane from Cl⁻ form into OH⁻ form and then washed with water.

Assuming complete oxidation of glycerol to CO₂ (14e-) and 100% efficiency (500 mV/cell), 10 kWh of electrical power per gallon of glycerol is available. In a preferred embodiment, we have produced 1000 mAh. In another preferred embodiment we have produced 2000 mAh. The preferred fuel cell has passed 200 mAh, about 20% of theory. Typical direct methanol fuel cells run at 30-40%, assuming 6e⁻ oxidation for MeOH and calculating the energy density by volume (not mass), the energy density of glycerol is equivalent to methanol.

The density of methanol is 0.792 g/mL whereas the density of glycerol is 1.226 g/mL, providing a 1.55 (ratio). Expressed as electrons transferred provides 14 for glycerol versus 6 for methanol, 2.33 ratio. 2.33*1.55=3.6, providing a fuel cell having a fuel that is almost 4 times as energy dense as methanol. Moreover, methanol must be run at dilute concentrations, in contrast to glycerol that can be run as 100% glycerol or even approximately 90% glycerol, the concentration in biodiesel waste. This provides up to 36 to 120 times the energy density of standard methanol fuel cells.

Complete conversion of methanol to CO₂ generates HCO₃⁻ and CO₃²⁻ (carbonic acid) in the presence of base. Carbonic acid fouls an anode catalyst in a standard alkaline fuel cell arrangement. However, this problem is overcome with the use of glycerol because complete conversion to CO₂ was not observed until after the majority of glycerol was consumed. Lower CO₂ concentration also extended the lifespan of the anode catalyst.

The present disclosure provides anode and cathode catalysts for fuel cells that utilize glycerol or biodiesel waste as the fuel source. In a preferred embodiment, the catalysts comprise metal complexes formed by platinum salts or alloys thereof and template polymers (WO2004/036674, the disclosure of which is incorporated by reference herein) prepared by condensation of a 4-{1-[(fenil-2,4-disubstituted)-hydrazine]-alkyl}-benzene-1,3-diol with a 3,5-disubstituted phenol and formaldehyde or para-formaldehyde in the presence of an acid or basic catalysts in water/alcohol mixtures and at a temperature comprised between 20-150° C. The metals to be used in combination with platinum are preferably selected from the group consisting of Au, Ag, Fe, Ru, Co, Rh, Ir, Ni, Pd, Mo, Sn, La, V, Mn, and combinations thereof. It is intended the fuel cells disclosed contain another liquid electrolyte, for example, a solution containing KOH, NaOH, LiOH or other electrolyte, either alkaline, neutral or acidic.

In addition a fuel cell is disclosed that incorporates a stack of disclosed fuel cells. This stack configuration avoids electrical short circuiting. For example, a series of pumps, valves, junctions, and/or check valves enable transfer and/or isolation of each individual fuel cell.

Preferred catalytic metal precursors for anode catalysts are iron, cobalt and nickel acetates and mixtures thereof coordinated to synthetic resins such as those described in the patent application PCT/EP2003/006592 (the disclosure of which is incorporated by reference herein) and specifically selected from the group consisting of acetate, palladium dichloride, iridium trichloride, rhodium trichloride, tin tetrachloride, ruthenium trichloride, and combinations thereof. Preferred catalytic metal precursors to cathode catalysts are cobalt, nickel and rhodium phthalocyanine or tetraphenylporphyrin, Co salen, Ni salen (salen ═N,N′-bis(salicylidene)ethylendiamine), silver nitrate, and combinations thereof. Preferred reducing agents have a reducing potential greater than the reducing potential of the metal compound from which the metal is to be reduced and is selected from the group consisting of hydrazine, hydrazine hydrate, alkali metal borohydrides, alkaline metal hydrosulfite, alkaline metal sulphites, and combinations thereof.

A platinum salt or a compound containing platinum, preferentially hexachloroplatinic acid (H₂PtCl₆), dissolved in water is added to an aqueous suspension of a templating polymer such as those described in WO 2004/036674, PCT/EP2003/006592, the disclosures of which are incorporated by reference herein. The solid product which is formed is filtered off, washed with water and dried in the air. Once dry, this solid is added to a suspension of a porous and conductive carbonaceous material, either amorphous or graphitic in nature, for instance Vulcan XC-72 or other activated carbon, in acetone or other organic solvents. The resultant product is treated with a reducing agent (for instance NaBH₄ or NH₂NH₂), filtered off, washed with water and dried.

The present disclosure provides an anodic and cathode electrode/catalysts for glycerol or biodiesel waster fuel cells comprising having either a Pt loading or a low content of platinum, consisting of metal complexes of platinum salts, or alloys thereof, and polymers obtained by condensation of a 4-{1-[(fenil-2,4-disubstituted)-hydrazine]-alkyl}-benzene-1,3-diol with a 3,5-disubstituted phenol and formaldehyde or paraformaldehyde in the presence of an acid or basic catalysts in water/alcohol mixtures and at a temperature comprised between 20-150° C.

Method 1: A platinum salt or a compound containing platinum, preferentially hexachloroplatinic acid (H₂PtCl₆), dissolved in water and a salt or a compound of another metal of the Periodic Table of the Elements, preferentially Fe, Ru, Co, Rh, Ir, Ni, Pd, Mo, Sn, La, V, Mn dissolved in water, are added to an aqueous suspension of the polymer. The solid product, which is formed after stirring for some hours is filtered off, washed with water and dried in the air. Once dry, this solid is added to a suspension of a porous and conductive carbonaceous material, either amorphous or graphitic in nature, for example Vulcan XC-72 or active carbon, in acetone or other organic solvents. The resultant product is treated with a reducing agent, for example, NaBH₄ or NH₂NH₂, filtered off, washed with water and dried. Alternatively, the product obtained by treatment of the polymer containing Pt and another metal with the carbonaceous material is isolated by solvent evaporation. After stirring for hours, the resultant material is filtered off, washed with water and dried; then, the metal complexed by the polymer and supported on the metal oxide is reduced with any of the methods described above.

Method 2: A platinum salt or a compound containing platinum, preferentially hexachloroplatinic acid (H₂PtCl₆), dissolved in water and a salt or a compound of another metal of the Periodic Table of the Elements dissolved in water and a third salt or compound of another metal dissolved in water (preferentially the two metals are in the group constituted by Fe, Ru, Co, Rh, Ir, Ni, Pd, Mo, Sn, La, V, Mn) are added to an aqueous suspension of the polymer. The solid product which is formed after stirring for some hours is filtered off, washed with water and dried in the air.

This solid is added to a suspension of a porous and conductive carbonaceous material, either amorphous or graphitic in nature, for example Vulcan XC-72 or active carbon, in acetone, isopropyl alcohol or other organic solvents. The resultant product is treated in situ with a reducing agent, for example, NaBH₄ or NH₂NH₂. The resultant product is filtered and dried or is isolated eliminating the solvent under reduced pressure. After stirring for hours, the resultant material is filtered off, washed with water and dried; then, the metals complexed by the polymer and supported on the metal oxide are reduced with any of the methods described above.

### Anode Preparation:

Method (a). The catalysts supported on conductive carbonaceous materials prepared by methods 1, 2 or 3 above are suspended into a water/ethanol mixture. This suspension is vigorously stirred and heated at a temperature between 60 and 80° C. PTFE (polytetrafluoroethylene) is added to the suspension and the resultant flocculous product is separated and then spread onto appropriate conductive supports such as carbon paper, steel nets or nickel or Ti plates or. The resultant electrode is heated to 350° C. for 10 hours.

Method (b). The products obtained by the reaction of the metal salts or metal compounds with the polymer are dissolved in a polar organic solvent such as acetone or dimethylformamide. A chosen aliquot of the resultant solution is deposited onto electrodes, dried and treated with a reducing agent (e.g., NaBH₄ or NH₂NH₂).

### Cathode Preparation and Catalysts

Method 3. A platinum salt or a compound containing platinum, preferentially hexachloroplatinic acid (H₂PtCl₆), dissolved in water is added to an aqueous suspension of the polymer. The solid product that is formed after stirring for 1 hour is filtered off, washed with water and dried. This solid is added to a suspension, in acetone or dimethylformamide or other polar organic solvent, of a conductive and porous carbonaceous material such as Vulcan XC-72 or active carbon. After stirring for hours, the solvent is removed under reduced pressure.

Method 4. A platinum salt or a compound containing platinum, preferentially hexachloroplatinic acid (H₂PtCl₆), dissolved in water and a salt or a compound of a metal of the Periodic Table of the Elements, preferentially nickel, cobalt, molybdenum, lanthanum, vanadium manganese, dissolved in water are added to an aqueous suspension containing the polymer. The solid product which is formed after hours is filtered off, washed and dried. The resultant solid product is added to an acetone or dimethylformamide suspension of a porous and conductive material such as Vulcan XC-72 or active carbon. After stirring, the solvent is removed under reduced pressure and the solid residue is heated in an oven to a temperature between 500 to 900° C.

### Cathode Preparation

The catalytic material previously obtained with methods 4 and 5 above is suspended in a hot mixture of water and ethanol. PTFE (polytetrafluoroethylene) is added to this suspension and the flocculous product that separates is spread and then pressed at room temperature onto appropriate conductive support materials such as carbon paper or stainless steel grids, Ti mesh, Ni Plates or Ti Plates. Then, the catalyzed support is heated to a temperature between 300 and 350° C. under an atmosphere of inert gas.

The metal particles of the catalysts are formed in originating structures featured by an anodic and cathodic activity in various kinds of fuel cells containing liquid electrolytes. The catalysts, whatever the metal or the combination of metals, do not form strong chemical bonds to gaseous CO. The anodes made with the catalysts can convert, into electrons and CO₂, a large variety of oxygenated compounds containing hydrogen atoms such as methanol, ethanol, ethylene glycol, glycerol, octane, acetaldehyde, formic acid, glucose, ascorbic acid, sorbitol, and structurally related hydrocarbon fuels, at ambient temperature and pressure. In general, however, the catalysts and the electrodes made with them can be used to catalyze the oxidation of any fuel containing hydrogen.

The cathodes made with the catalysts convert pure oxygen or oxygen from air into water or into hydroxide ions (OH⁻).

The catalyzed anode and cathode electrodes, with platinum alone or in combination with other metals, for example, Fe, Ru, Co, Rh, Ir, Ni, Pd, Mo, Sn, V, Mn, are used in liquid fuel cells. Anodes for liquid fuel cells containing platinum alone or in combination with other metals, for example, Fe, Ru, Co, Rh, Ir, Ni, Pd, Mo, Sn, La, V, Mn allow the use of polyhydric alcohols and fuel, such as glycerol. Such fuel cells contain a quantity of platinum preferably 0.20 mg/cm² or lower. Such fuel cells allow use of the whole specific energy of glycerol fuel converting it into highly oxidized polyhydric species.

The utility of using various polyhydric mixtures, including crude glycerin in a direct fuel cell, can be analyzed from the fuel cell performance. The fuel cell performance can be determined by a standard polarization curve. Polarization curves were obtained for fuel combinations and mixtures, membranes, and catalysts. The polarization curve includes the measured cell voltage, current, and the calculated current and power output of the cell at a given resistive load. To obtain the polarization curve the cell voltage is measured for a series of resistances. The current and power are both calculated from Ohm's law, V=I/R. It is to be noted that all of the following examples of fuel mixtures, membranes and catalysts exhibited suitable fuel cell performances.

The fuel cell performance over extended periods was determined by placing a constant resistance across the cell. The voltage response during the testing period was measured and the total energy produced by the electrochemical oxidation of the polyhydric mixtures was determined by integrating the fuel cell power output over the length of the experiment.

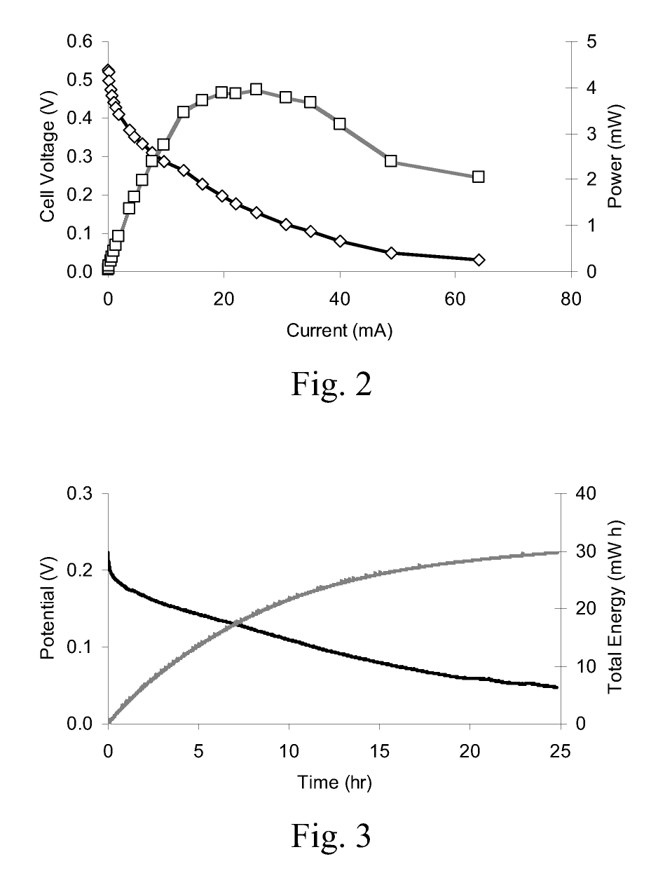

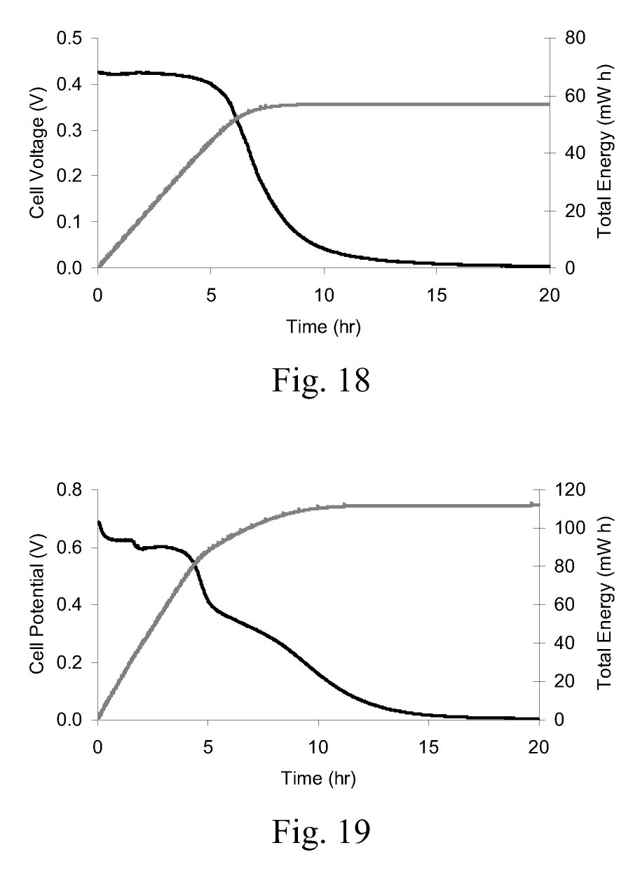

An example of a polyhydric alcohol used directly in a single-cell direct fuel cell is a membrane electrode assembly (MEA) comprising a proton-exchange membrane, a Pt—Ru/C anode and a Pt/C cathode. The performance of fuel cells containing said MEA for polyhydric fuels and fuel mixtures are given in FIG. 2 through FIG. 7, FIGS. 18 and 19.

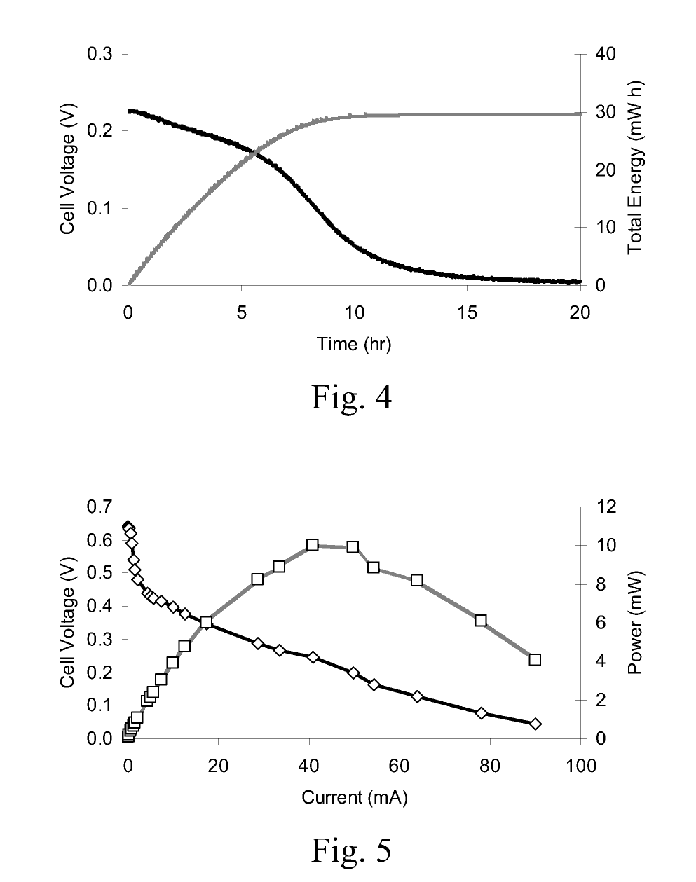

FIG. 2 is the polarization curve and FIG. 3 is the voltage response (V) and corresponding energy (mWh) at a constant resistive load for 1.5 M glycerol fuel and ambient-air oxidant. Whereas FIG. 4 is the voltage response (V) and corresponding energy (mWh) at a constant resistive load for 10% ethanol fuel and ambient-air oxidant.

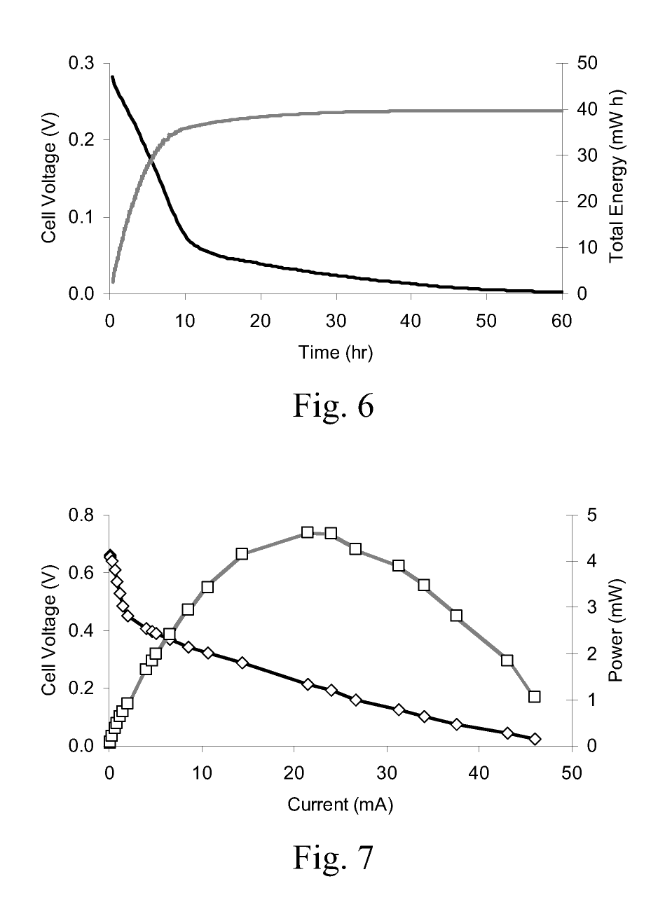

FIG. 5 is the polarization curve for 1M ethylene glycol fuel and FIG. 7 is the polarization curve for 3 M propanediol fuel. FIG. 6 is the total power from the 1 M ethylene glycol fuel. All the cells were tested under ambient conditions using air as the oxidant.

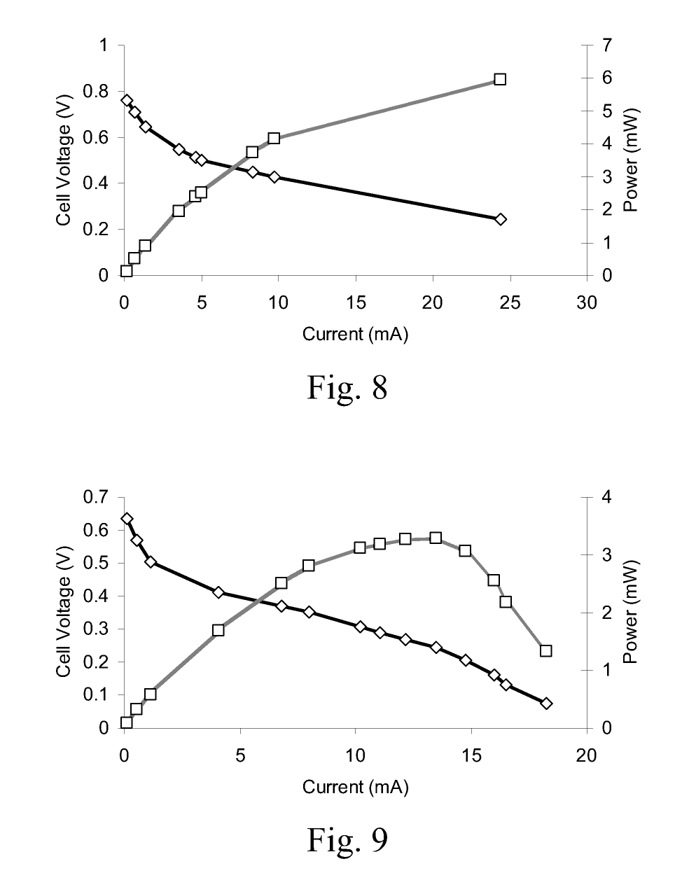

An example of a polyhydric alcohol used directly in a single-cell direct fuel cell is a membrane electrode assembly (MEA) consisting of an anion-exchange membrane, a Pt—Ru/C anode and a Pt/C cathode. The performance of fuel cells containing said MEA for polyhydric fuels and fuel mixtures are given in FIG. 8 through FIG. 15 and FIG. 20.

FIG. 8 and FIG. 9 are polarization curves for 3% methanol in 3 M KOH. The MEA of FIG. 8 comprises an anion-exchange membrane obtained from Tokuyama (AHA-006) and FIG. 9 had an MEA consisting of an undisclosed anion-exchange membrane obtained from eVionyx. Both examples used ambient-air as oxidant.

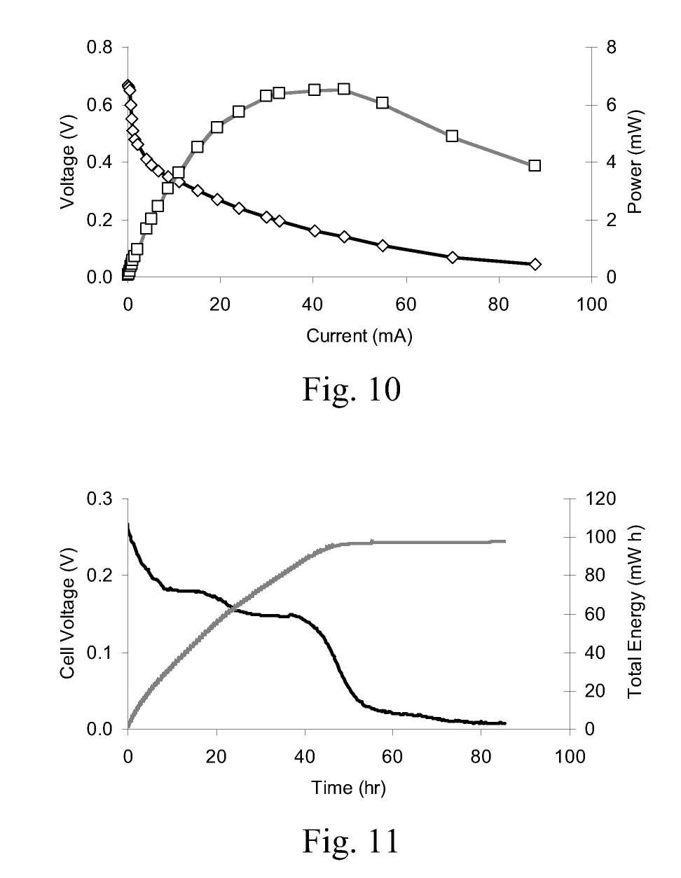

In another preferred embodiment, 5% glycerol in 3 M KOH is used as fuel. FIG. 10 is the cell voltage (V), current (mA), and corresponding power (mW) at a given resistance and FIG. 11 is the voltage response (V) and corresponding energy (mWh) at a constant resistive load for a fuel cell containing an anion-exchange membrane, a Pt—Ru/C anode, a Pt/C cathode.

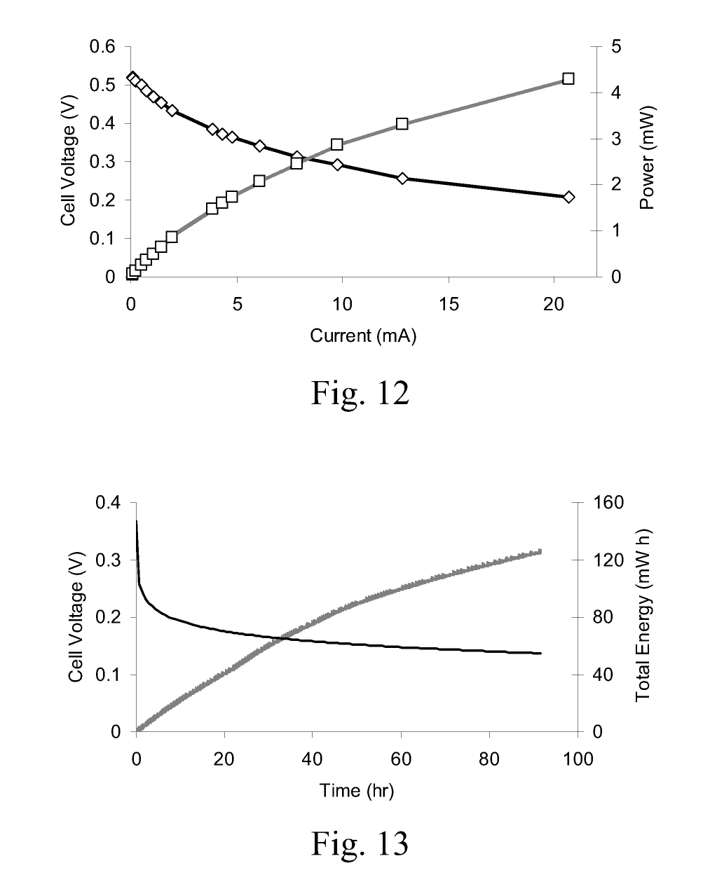

FIG. 12 is the cell voltage (V), current (mA), and corresponding power (mW) at a given resistance for a fuel cell containing an anion-exchange membrane obtained from AGC (AHT) with a Pt—Ru/C anode, a Pt/C cathode, and 25% glycerol fuel, 3 M KOH, and ambient-air oxidant.

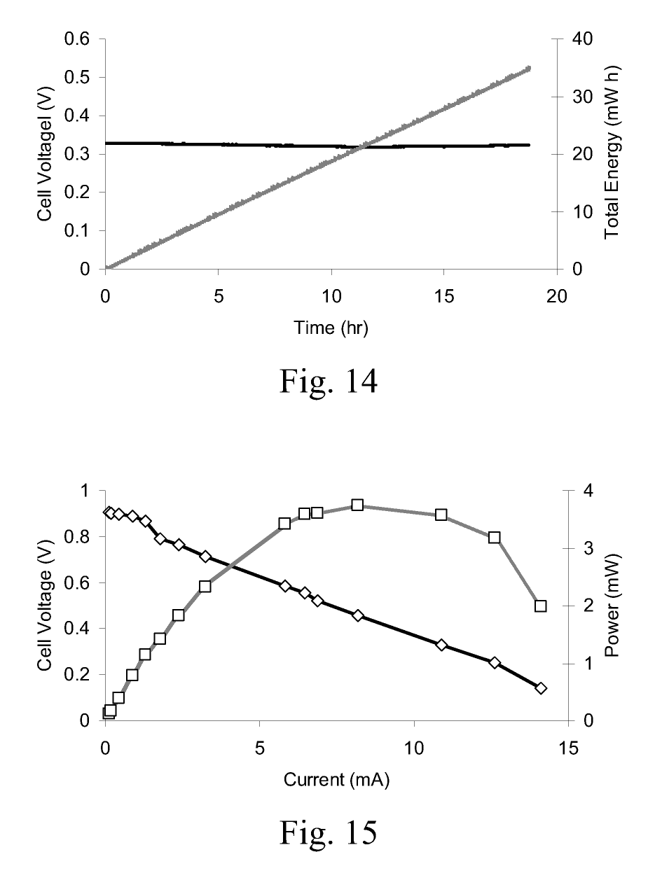

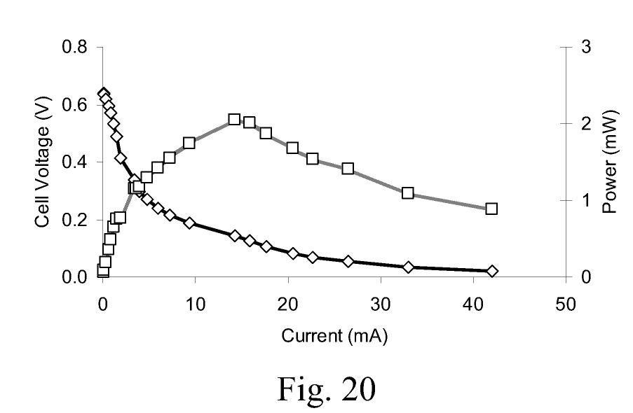

FIG. 13 is the voltage response (V) and corresponding energy (mWh) for 50% glycerol fuel saturated KOH at a constant resistive load and FIG. 14 is the voltage response (V) and corresponding energy (mWh) for 10% glycerol both fuel cells contain an anion-exchange membrane obtained from eVionyx, with a Pt—Ru/C anode, a Pt/C cathode and ambient-air oxidant. FIG. 20 is the cell voltage (V), current (mA), and corresponding power (mW) for 3 M propanediol fuel, with 3 M KOH.

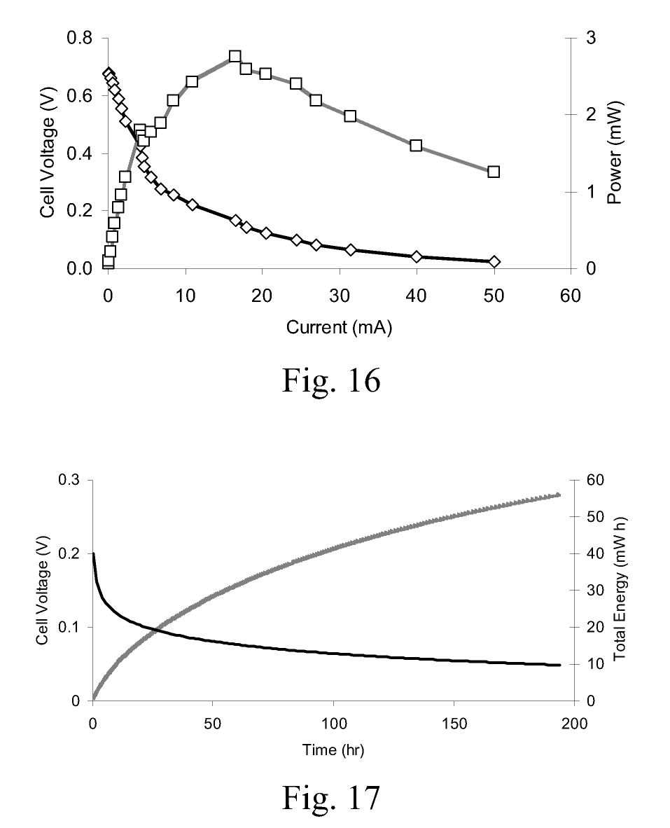

FIG. 15 is the cell voltage (V), current (mA), and corresponding power (mW) at a given resistance for a fuel cell containing an anion-exchange membrane, a Pt—Ru/C anode, a Pt/C cathode, and 25% crude glycerol fuel that is saturated with KOH. FIG. 16 is the cell voltage (V), current (mA), and corresponding power (mW) at a given resistance for a fuel cell containing an anion-exchange membrane, a Pd—Ni—Fe anode, a Pd—Co cathode, 25% crude glycerol fuel, saturated KOH, and ambient-air oxidant. Whereas, FIG. 17 is the voltage response (V) and corresponding energy (mWh) at a constant resistive load for a fuel cell containing an anion-exchange membrane, a Pd—Ni—Fe anode, a Pd—Co cathode, 25% crude glycerol fuel, saturated KOH, and ambient-air oxidant.

FIG. 18 and FIG. 19 demonstrate the total power and power duration for 30% methanol and 30% 2-propanol fuels at a constant resistive load. Although the power output for both these fuels is exceptionally high, the duration of the power output is significantly lower than other examples disclosed. The alcohols were used directly in a single-cell direct fuel cell is a membrane electrode assembly (MEA) consisting of a proton-exchange membrane, a Pt—Ru/C anode and a Pt/C cathode. All the cells were tested under ambient conditions using air as the oxidant.

### EXAMPLE 1

This example describes a method for catalyst preparation forming catalyst on a polymer substrate. To a suspension of 1 g of the known polymer in 100 ml of water is added 0.2 g of hexachloroplatinic acid (H₂PtCl₆). The pH of the resulting mixture is fixed at 9 by addition of 50 mL of NaOH. 1.0M of the mixture is vigorously stirred at room temperature for 6 hours. A dark red precipitate is formed which is filtered off, washed several times with distilled water and dried under reduced pressure at 70° C. until constant weight. Yield=0.8 g. Pt content=6 wt. %.

A suspension of 0.5 g of the red precipitate in 100 mL of acetone (finely dispersed by sonication for 30 min) is added 5 g of Vulcan XC-72R (previously activated and purified by reflux in 100 mL of 1 M HNO₃, filtered off, washed with water several times and heated at 600° C. for 2 hours). This suspension is vigorously stirred at room temperature for 4 hours. Then it is cooled to 0° C., and 0.7 g of NaBH₄ is slowly added portion-wise. The mixture is allowed to reach room temperature and after 2 hours, the solid residue is filtered off, washed with water (3×50 ml) and dried under reduced pressure at 70° C. until constant weight. Pt content=0.55 wt. %.

### EXAMPLE 2

This example illustrates a preparation of a Pt—Ru anodic catalyst. To a suspension of 1 g of POLIMER in 100 mL of water is added 0.2 g of hexachloroplatinic acid (H₂PtCl₆) dissolved in 20 mL of water and 0.31 g of ruthenium trichloride trihydrate (RuCl₃*3H₂O) dissolved in 20 mL of water. The pH of the resulting mixture is fixed at 9 by adding 50 mL of NaOH (1M) and the mixture is vigorously stirred at room temperature for 6 hours. A dark brown product is formed, which is filtered off, washed several times with distilled water and dried under reduced pressure at 70° C. until constant weight. Yield 0.9 g. Pt content=6 wt. %, Ru content=7 wt. %.

A suspension of 0.5 g of the dark brown product is suspended in 100 mL of acetone (finely dispersed by sonication for 30 min.) and added to 5 g Vulcan XC-72R (previously activated and purified by reflux in 100 mL of 1 N HNO₃, filtered off, washed with water several times and heated at 800° C. for 2 h). This suspension is vigorously stirred at room temperature for 4 hours and then cooled to 0° C. and then added portion-wise to 1.5 g of NaBH₄. The resulting mixture is allowed to reach room temperature for 2 hours.

### EXAMPLE 3

This example illustrates the preparation of platinum-ruthenium-nickel anodic catalyst. To a suspension of 1 g of polymer in 100 mL of water is added 0.2 g of hexachloroplatinic acid (H₂PtCl₆) dissolved in 20 mL of water and 0.31 g of ruthenium trichloride trihydrate (RuCl₃*3H₂O) dissolved in 20 mL of water, and 0.06 g of nickel acetate tetrahydrate [Ni(CH₃CO₂)₂4H₂O] dissolved in 20 mL of water. The pH of the resulting mixture is fixed at 9 by adding 50 mL of NaOH 1M and the mixture is vigorously stirred at room temperature for 6 hours. A dark red product is formed, which is filtered off, washed several times with distilled water and dried under reduced pressure at 70° C. until constant weight. Yield 0.9 g. Pt content=6 wt. %, Ru content=7 wt. %, Ni content 1.2 wt %.

A suspension of 0.5 g of the dark red product is suspended in 100 mL of acetone (finely dispersed by sonication for 30 min) and added 5 g Vulcan XC-72R (previously activated and purified by reflux in 100 mL of 1 N HNO₃, filtered off, washed with water several times and heated at 800° C. for 2 hours). This suspension is vigorously stirred at room temperature for 4 hours and then cooled to 0° C. and then added portion-wise to 1.5 g of NaBH₄. The resulting mixture is allowed to reach room temperature for 2 hours. Afterwards, the solid residue is filtered off, washed with water (3×50 mL) and dried under reduced pressure at 70° C. until constant weight. Pt content=0.55 wt. %, Ru contents 0.66 wt. %, Ni content=0.1 wt. % (ICP-AES).

Alternatively, the reduction of the metal can be achieved using a stream of hydrogen gas (1 bar). In this case, 5 g of the mixture containing the Polymer-Pt—Ru—Ni and Vulcan (1:10 w/w), is introduced into quartz tubular reactor and then heated in a stream of hydrogen at 360° C. for 2 hours. Pt content=0.55 wt. %; Ru content=Ru-0.66 wt. %, Ni content=0.1 wt. % (ICP-AES). Atomic ratio (%)=Pt41Ru50Ni9.

### EXAMPLE 4

This example illustrates the preparation of platinum-based cathodic catalyst. To a suspension of 2 g of the Polymer in 200 mL of water is added 0.4 g of hexachloroplatinic acid (H₂PtCl₆). The pH of the resulting mixture is fixed at 9 by addition of 100 mL of NaOH 1M. The, the mixture is vigorously stirred at room temperature for 10 hours. A dark red precipitate is formed which is filtered off, washed several times with distilled water and dried under reduced pressure at 70° C. until constant weight. Yield=1.8 g. Pt content=6 wt. %.

A suspension of 0.5 g of the dark red precipitate is suspended in 100 mL of acetone (finely dispersed by sonication for 30 min) and added 5 g Vulcan XC-72R (previously activated and purified by reflux in 100 mL of HNO₃ 1N, filtered off, washed with water several times and heated at 800° C. for 2 h). This suspension is vigorously stirred at room temperature for 3 hours and then the solvent is evaporated under reduced pressure. The solid residue is heated at 600° C. for 2 hours. Pt content=0.55 wt %).

### EXAMPLE 5

This example shows the preparation of platinum-nickel cathodic catalyst. A suspension of 2 g of Polymer in 200 mL of water is added 0.4 g of hexachloroplatinic acid (H₂PtCl₆) dissolved in 30 mL of water and 0.1 g of nickel acetate tetrahydrate [Ni(CH₃CO₂)₂*4H₂O] dissolved in 20 mL of water. The pH of the resulting mixture is fixed at 9 by adding 100 mL of 1 M NaOH and the mixture is vigorously stirred at room temperature for 10 hours. A dark red product is formed, which is filtered off, washed several times with distilled water and dried under reduced pressure at 70° C. until constant weight. Yield 1.8 g. Pt content=6 wt. %, Ni content=0.6 wt. %.

A suspension of 0.5 g of the dark red product is suspended in 100 mL of acetone (finely dispersed by sonication for 30 min.) and added 5 g Vulcan XC-72R (previously activated and purified by reflux in 100 mL of 1 N HNO₃, filtered off, washed with water several times and heated at 800° C. for 2 hours in a stream of an inert gas). This suspension is vigorously stirred at room temperature for 3 hours and then the solvent is evaporated under reduced pressure. The solid residue is introduced into a quartz reactor and heated at 600° C. for 2 hours. Pt content=0.55 wt %, Ni content=0.06 wt. %. Atomic ratio (%)=Pt90Ni10.

### EXAMPLE 6

This example describes the preparation of a platinum-cobalt cathodic catalyst. To a suspension of 2 g of Polymer in 200 mL of water is added 0.4 g of hexachloroplatinic acid (H₂PtCl₆) dissolved in 30 mL of water and 0.1 g of cobalt acetate tetrahydrate [Co(CH₃CO₂)*4H₂O] dissolved in 20 mL of water. The pH of the resulting mixture is fixed at 9 by adding 100 mL of 1 M NaOH and the mixture is vigorously stirred at room temperature for 10 hours. A dark red product is formed, which is filtered off, washed several times with distilled water and dried under reduced pressure at 70° C. until constant weight. Yield 1.8 g. Pt content=6 wt. %, Co content=0.7 wt. %.

A suspension of 0.5 g of the dark red product is suspended in 100 mL of acetone (finely dispersed by sonication for 30 min) is added 5 g Vulcan XC-72R (previously activated and purified by reflux in 100 mL of 1 N HNO₃, filtered off, washed with water several times and heated at 800° C. for 2 hours). This suspension is vigorously stirred at room temperature for 3 hours and then the solvent is evaporated under reduced pressure. The solid residue is heated at 600° C. for 2 hours. Pt content=0.55 wt %, Co content=0.07 wt. %, Atomic ratio (%)=Pt89Co11.

### EXAMPLE 7

This example shows the preparation of an anode for a fuel cell. 10 g of a compound obtained with the procedure described in examples 1, 2 and 3 was suspended in 100 mL of a water/ethanol mixture (1:1, v:v). This suspension was vigorously stirred and 3.5 g of PTFE (polytetrafluoroethylene) dispersed in water (60 wt %) was added. After 20 min., a flocculous product was formed which is separated by decantation. In alternative to Vulcan, all the conductive carbonaceous materials can be used, such as active carbon, R-5000, NSN-III or graphite or Ketjen black.

Method (a): 200 mg of the product was uniformly spread on a carbon paper disc (Teflon®-treated carbon paper, Fuel Cell Scientific). The electrode so formed was sintered by heating at a 350° C. for 30 minutes. Method (b): 200 mg of the product FC were uniformly spread on a stainless steel, Ti, or Ni grid which is then pressed at 100 Kg/cm². The electrode so formed was sintered by heating in an oven at a 350° C. for 30 minutes. Method (c): 0.5 ml of a suspension in acetone (50 ml) of 200 mg of the Polymer containing the metal compounds described in examples 1, 2 and 3, before they are reduced with the methods describe, were deposited on various supports differing for the shape and dimensions of a conductive material, for instance silver or nickel powders pressed and sintered. The supports containing the catalyst were then immersed into an aqueous solution (100 ml) of 1 g of NaBH₄ for 10 min. at room temperature. The reduction of the metal salts can also be achieved by introducing the supports impregnated with the metal(s)-containing Polymer was heated at 365° C. for 2 hours.

### EXAMPLE 8

This example illustrates the preparation of a cathode for a fuel cell. 10 g of the compound obtained with the methods described in examples 4, 5 and 6 was suspended in 100 mL of a 1:1 (v/v) water/ethanol mixture. This suspension was vigorously stirred, and 3.5 g of PTFE (polytetrafluoroethylene) dispersed in water (60 wt. %) was added. After 20 min. a flocculous product (CF) was generated, which was separated by decantation. In the place of Vulcan, active carbon RDBA, R-5000, NSN-III, or Ketjen black, and other materials may be used as conductive support.

Method (a): 100 mg of product were spread onto a stainless-steel, Ni, or Ti net or grid which was then pressed at 100 Kg/cm². The electrode so formed was sintered by heating in an oven at 350° C. for 30 minutes

Method (b): 0.5 mL of a suspension of 200 mg of the Polymer containing the metals described in examples 4, 5 and 6, in 50 mL of acetone is deposited on a support obtained by pressing conductive metals, such as powdered Silver or nickel. The support is heated to 500° C. for 30 minutes.

### EXAMPLE 9

This example shows the electrochemical oxidative properties of biodiesel waste byproducts. We used solutions containing 3% methanol or glycerol with 0.1M KCl, NaOH or KOH or HCl to mimic various biodiesel waste processing streams. The biodiesel waste solution used was 3-4% glycerol, by weight. It was neutralized with HCl to bring the putative glycerol concentration to as high as 0.3M and the pH to the 6.5-7.0 range. The solution turned opaque white (likely due to soap residue).

### EXAMPLE 10

Electrocatalytic oxidation of several oxygenated organic compounds was investigated on gold electrodes both in acid and alkaline medium using cyclic voltametry. The oxygenated organic compounds were ethanol, ethylene glycol, acetaldehyde, glycoaldehyde, glyoxal, acetic acid, glycolic acid, glyoxylic acid, oxalic acid, glycerol and four butanol isomers. Gold was a poor electrocatalyst in an acid medium, except for the oxidation of glyoxylic acid and oxalic acid. However, it was determined that gold was a good electrocatalyst in an alkaline medium for the oxidation of aldehyde or alcohol moieties.

For the anode and glycerol, C₃H₈O₃+14OH⁻ yielded 3CO₂+11H₂O+14e⁻. Overall the yield was C₃H₈O₃+7/2O₂ yielded 3CO₂+4H₂O.

We claim:

1. A method for using a liquid fuel composition obtained from biodiesel waste as the fuel in a fuel cell having an anion exchange membrane, wherein the liquid fuel composition comprises 5-80% glycerin, 1-20% hydroxyl ion, 0.5-10% methanol, and from about 1-40% of impurities selected from the group consisting of trace methyl or ethyl esters, ethanol, ethylene glycol, propanol, soaps, incomplete transesterification of triglycerides, and mixtures thereof.

2. The method for using a liquid fuel composition obtained from biodiesel waste as the fuel in a fuel cell having an anion exchange membrane of claim 1 wherein the hydroxyl ion is from a salt selected from the group consisting of LiOH, NaOH, KOH and mixtures thereof.

3. A fuel cell device for oxidizing a biodiesel processing waste comprising:
(a) a chamber having a first and a second sealed outer walls defining an inner chamber having three compartments;
(b) an oxygen compartment defined be the first outer wall of the chamber and a cathode polymeric strand electro-catalyst assembly;
(c) a biodiesel waste compartment defined by the second outer wall of the chamber and an a anode polymeric strand electro-catalyst assembly; and
(d) an electrolyte compartment defined by the cathode polymeric strand electro-catalyst assembly and the anode polymeric strand electro-catalyst assembly, wherein the electrolyte compartment comprises a base solution.

4. The fuel cell device for oxidizing a biodiesel processing waste of claim 3 wherein the anode and cathode polymeric strand electro-catalyst assembly comprise (i) a porous conducting polymer material, (ii) coated with an electrically conductive metal layer that, itself, acts as a support material for (iii) catalytically active metals or metal compounds.

5. The fuel cell device for oxidizing a biodiesel processing waste of claim 4 wherein the metallic coating layer is composed of a metal compound selected from the group consisting of Ag, Au, Ni, Co, Cu, Pd, Sn, Ru, and alloys thereof.

6. The fuel cell device for oxidizing a biodiesel processing waste of claim 5 wherein the metallic coating layer is selected from the group consisting of nickel and cobalt citrate, potassium tetrachloroplatinate, silver nitrate, cobalt nitrate, potassium tetrachloroaurate, and mixtures thereof.

7. The fuel cell device for oxidizing a biodiesel processing waste of claim 3 wherein the anode polymeric strand electro-catalyst assembly is made from a metal selected from the group consisting of Pt, Au, Ag, Ni, Co, Fe, Ru, Sn, Pd, and combinations thereof.

8. The fuel cell device for oxidizing a biodiesel processing waste of claim 7 wherein the porous conducting polymer material is composed of a polymeric material selected from the group consisting of polyporryphrin, polyolefins, fluorinated ethylene/polypropylene copolymers, polysulfones, ethylene oxide-polyepichlorohydrin copolymers, chloromethylation or sulfochloromethylation.

9. The fuel cell device for oxidizing a biodiesel processing waste of claim 8 wherein the ethylene oxide-polyepichlorohydrin copolymers are prepared by grafting with radiation.

10. The fuel cell device for oxidizing a biodiesel processing waste of claim 3 wherein the anode catalysts are selected from the group consisting of Pt, Au, Ag, Ni, Co, Fe, Ru, Sn, Pd and combinations thereof.

11. The fuel cell device for oxidizing a biodiesel processing waste of claim 3 wherein the cathode catalysts are selected from the group consisting of cobalt, nickel and rhodium phthalocyanine or tetraphenylporphyrin, Co N,N′-bis(salicylidene)ethylendiamine, Ni N,N′-bis(salicylidene)ethylendiamine silver oxide, and combinations thereof. the oxygen compartment further comprises an oxygen source that is a gas or a liquid, wherein the gas is air or pure oxygen.

12. The fuel cell device for oxidizing a biodiesel processing waste of claim 3 wherein the base solution is selected from the group consisting of potassium hydroxide, sodium hydroxide, hydrazine, hydrazine hydrate, alkali metal borohydrides, alkaline metal hydrosulfite, alkaline metal sulphites, and combinations thereof.

13. A liquid fuel cell that utilizes glycerol or biodiesel waste as a fuel, comprising:
(a) an anode chamber comprising a sealed endplate, an anion exchange membrane having a first side and a second side, and the glycerol or biodiesel processing waste fuel, wherein the endplate and the first side of the anion exchange membrane form the anode chamber; and
(b) a oxygen chamber comprising a second sealed endplate, the second side of the anion exchange membrane, a cathode polymeric strand electro-catalyst assembly, and an oxygen source.

14. The liquid fuel cell that utilizes glycerol or biodiesel waste as a fuel of claim 13, wherein the oxygen source is a gas or a liquid, wherein the gas is air or pure oxygen, and wherein the liquid is a peroxide solution.

15. The liquid fuel cell that utilizes glycerol or biodiesel waste as a fuel of claim 13, wherein, the anion exchange membrane is made from a quaternized polymers selected from the group consisting of polysiloxane containing a quaternary ammonium group, poly(oxyethylene) methacrylates containing ammonium groups, quaternized polyethersulfone cardo anion exchange membranes, radiation-grafted polyvinylidene fluoride (PVDF) and polytetrafluoroethylene-co-hexafluoropropylene (FEP), and combinations thereof.

16. The liquid fuel cell that utilizes glycerol or biodiesel waste as a fuel of claim 13, wherein the anode and cathode membrane electrode assembly (MEA) comprise (i) a porous conducting polymer material, (ii) coated with an electrically conductive metal layer that, itself, acts as a support material for (iii) catalytic metals or metal compounds.

17. The liquid fuel cell that utilizes glycerol or biodiesel waste as a fuel of claim 16, wherein the metallic coating layer is composed of a metal compound selected from the group consisting of Ag, Au, Ni, Co, Cu, Pd, potassium tetrachloroplatinate, silver nitrate, cobalt nitrate, potassium tetrachloroaurate, and combinations thereof.

18. The liquid fuel cell that utilizes glycerol or biodiesel waste as a fuel of claim 16, wherein the anode MEA is made from a metal selected from the group consisting of Pt, Au, Ag, Ni, Co, Fe, Ru, Sn, Pd, and combinations thereof.

19. The liquid fuel cell that utilizes glycerol or biodiesel waste as a fuel of claim 16, wherein the porous conducting polymer material is composed of a polymeric material selected from the group consisting of polyporryphrin, polyolefins, fluorinated ethylene/polypropylene copolymers, polysulfones, ethylene oxide-polyepichlorohydrin copolymers, chloromethylation or sulfochloromethylation.

20. A liquid fuel cell that utilizes glycerol or biodiesel waste as the fuel, comprising:
(a) an anode chamber comprising a sealed endplate, the glycerol or biodiesel waste fuel, and anode membrane electrode assembly, and a proton exchange membrane having a first side and a second side, wherein the endplate and the first side of the proton exchange membrane form the anode chamber, and
(b) a oxygen chamber defined by a second sealed endplate and the second side of the proton exchange membrane and comprising a cathode polymeric strand electro-catalyst assembly (cathode MEA) and an oxygen source.

21. The liquid fuel cell that utilizes glycerol or biodiesel waste as a fuel of claim 20, wherein the oxygen source is a gas or a liquid, wherein the gas is air or pure oxygen, and wherein the liquid is a peroxide solution.

22. The liquid fuel cell that utilizes glycerol or biodiesel waste as a fuel of claim 20, wherein the proton exchange membrane (PEM) is made from a fluoropolymer having sulfonated functional groups, wherein the fluoropolymer having sulfonated functional groups is a poly-perfluorovinyl ether terminated with sulfonate groups onto a tetrafluoroethylene (Teflon) backbone.

23. The liquid fuel cell that utilizes glycerol or biodiesel waste as a fuel of claim 20, wherein the anode and cathode membrane electrode assembly (MEA) comprise (i) a porous conducting polymer material, (ii) coated with an electrically conductive metal layer that, itself, acts as a support material for (iii) catalytically active metals or metal compounds.

24. The liquid fuel cell that utilizes glycerol or biodiesel waste as a fuel of claim 23, wherein, the metallic coating layer is composed of a metal compound selected from the group consisting of Ag, Au, Ni, Co, Cu, Pd, Sn, Ru, potassium tetrachloroplatinate, silver nitrate, cobalt nitrate, potassium tetrachloroaurate, and combinations thereof.

25. The liquid fuel cell that utilizes glycerol or biodiesel waste as a fuel of claim 23, wherein the anode MEA is made from a metal selected from the group consisting of Pt, Au, Ag, Ni, Co, Fe, Ru, Sn, Pd compounds, and combinations thereof.

26. The liquid fuel cell that utilizes glycerol or biodiesel waste as a fuel of claim 23, wherein the porous conducting polymer material is composed of a polymeric material selected from the group consisting of polyporryphrin, polyolefins, fluorinated ethylene/polypropylene copolymers, polysulfones, ethylene oxide-polyepichlorohydrin copolymers, chloromethylation or sulfochloromethylation.

27. The liquid fuel cell that utilizes glycerol or biodiesel waste as a fuel of claim 23, wherein the anode catalysts are selected from the group consisting of Pt, Au, Ag, Ni, Co, Fe, Ru, Sn, Pd, and combinations thereof.

28. The liquid fuel cell that utilizes glycerol or biodiesel waste as a fuel of claim 23, wherein the cathode catalysts are selected from the group consisting of cobalt, nickel and rhodium phthalocyanine or tetraphenylporphyrin, Co N,N′-bis(salicylidene)ethylendiamine, Ni N,N′-bis(salicylidene)ethylendiamine, silver nitrate, and combinations thereof.
